(19) United States
(12) Patent Application Publication
(10) Pub. No.: US 2010/0231763 A1
(43) Pub. Date: Sep. 16, 2010

(54) DEFECTIVE PIXEL DETECTOR FOR A DIGITAL VIDEO CAMERA AND ASSOCIATED METHODS

(75) Inventors: Joseph Deschamp, Schwenksville, PA (US); David Guerrero, Center Valley, PA (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Corporation of the State of Delaware, Melbourne, FL (US)

(21) Appl. No.: 12/404,497

(22) Filed: Mar. 16, 2009

(51) Int. Cl. H04N 9/64

(52) U.S. Cl. 348/246

(57) ABSTRACT

A defective pixel tester determines defective pixels within a digital video camera. The tester includes a video input, a memory and a controller. The video input receives video frames from the digital video camera, with each video frame defined by a plurality of pixel values. The memory stores captured video frames and pixel test results. The controller generates difference values for corresponding pixel values from different video frames, generates pixel test results based upon a comparison of the difference values to a threshold, and stores the pixel test results in the memory.

### FIELD OF THE INVENTION

The present invention relates to the field of imaging devices, and more particularly, to a tester for determining defective pixels and associated methods.

### BACKGROUND OF THE INVENTION

Imaging devices, such as digital video cameras, typically include image sensors that are manufactured as charge coupled devices (CCDs) or complementary metal-oxide semiconductor (CMOS) devices. An image sensor comprises an array of pixels that captures energy from a light source. The image sensor converts the captured energy from each pixel into an electrical measurement representing an intensity value.

Typically, an image sensor will have a certain number of pixel locations that are defective due to fabrication or manufacturing errors. A defective pixel of an image sensor is one that when exposed to a light source will produce a different intensity value or response than that of a fully functional pixel when exposed to that same light source.

Pixel defects include pixels that may be stuck-on or stuck-off. A stuck-on defective pixel is one that always responds to the lighting condition by producing a high intensity value. For instance, if the pixel intensity ranges from 0 to 255, a stuck-on pixel may always respond to the lighting condition with a value of 250, for example, even if the actual measured intensity for that location of the scene would be considerably less if captured by a functional pixel. A stuck-off defective pixel is one that always responds to the lighting condition by producing a low intensity value. In the same system, a stuck-off defective pixel may respond with a low value of 5, for example, even if the actual measured intensity for that location of the scene would be considerably more if captured by a functional pixel.

One approach for determining defective pixels within a digital video camera is disclosed in U.S. Patent Application No. 2007/0091187. An image signal processor device within the digital video camera includes a surrounding pixel interpolator for calculating an average value of same colored pixels surrounding a pixel under evaluation in a portion of a digital image representation. A pixel evaluator is coupled to the surrounding pixel interpolator for determining if the pixel under evaluation is defective based on a comparison with its surrounding pixels. A drawback of this approach is that a large amount of processing may be used within the camera for determining defective pixels, which adds to the complexity of the camera.

Alternatively, defective pixels within a digital video camera may be determined using an external defective pixel tester that is coupled to the camera. The camera operator points the camera at a white field and takes a picture. This determines the stuck-off pixels. The camera operator also points the camera at a black field and takes a picture. This determines the stuck-on pixels. A drawback of this approach is that special backgrounds are required during testing.

### SUMMARY OF THE INVENTION

In view of the foregoing background, it is therefore an object of the present invention to provide a defective pixel detector for a digital video camera that does not use special colored backgrounds for performing the testing.

This and other objects, features, and advantages in accordance with the present invention are provided by a defective pixel tester for determining defective pixels within a digital video camera, wherein the tester comprises a video input, at least one memory and a controller. The video input may be for receiving video frames from the digital video camera, with each video frame being defined by a plurality of pixel values. The at least one memory may be for storing captured video frames and pixel test results. The controller may be for generating difference values for corresponding pixel values from different video frames, generating pixel test results based upon a comparison of the difference values to a threshold, and storing the pixel test results in the at least one memory.

The controller may perform the generating and storing on successive video frames. The video frames received by the video input may be in real time.

The controller may comprise a comparator for generating the difference values, and a threshold circuit for comparing the difference values to the threshold. The defective pixel tester may further comprise a display cooperating with the at least one memory for displaying the pixel test results.

In operation, the defective pixel tester may be coupled to the video output of the camera using an interface cable. The digital video camera may provide video frames to the defective pixel tester while operating in a normal camera mode. The defective pixel tester advantageously compares the received video frames for determining if there are defective pixels within the digital video camera. The testing may advantageously be performed without the use of special colored backgrounds.

The at least one memory may be a single memory, for example, comprising a video frame store section for storing captured video frames, and a pixel test results section for storing pixel test results. Alternatively, a memory device may be provided for the video frame store section, and a separate memory device may be provided for the pixel test results section. The controller may reset the pixel test results section prior to determining defective pixels within the digital video camera.

The controller may receive a current captured video frame from the video frame store section and a new video frame as received by the video input. The controller may perform the generating and storing on these two video frames. The new video frame may also be stored in the video frame store section as a new current captured video frame. The controller may then receive the new current captured video frame from the video frame store section and a different new video frame from the video input. The controller may repeat the generating and storing on these two video frames. In other words, the controller may repeat the generating and storing using one of the video frames previously used to generate the pixel test results last stored in the at least one memory.

Another aspect is directed to a method for determining defective pixels within a digital video camera using a defective pixel tester as described above. The method may comprise receiving video frames at the video input from the digital video camera, with each video frame being defined by a plurality of pixel values, and storing in the at least one memory captured video frames and pixel test results. The controller may be operated for generating difference values for corresponding pixel values from different video frames, generating pixel test results based upon a comparison of the difference values to a threshold, and storing the pixel test results in the at least one memory.

### BRIEF DESCRIPTION OF THE DRAWINGS

FIG. 1 is a block diagram of a defective pixel detector coupled to a digital video camera in accordance with the present invention.

FIG. 2 is a more detailed block diagram of the defective pixel tester and the digital video camera as illustrated in FIG. 1.

FIG. 3 is a flow chart illustrating a method for determining defective pixels within a digital video camera in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

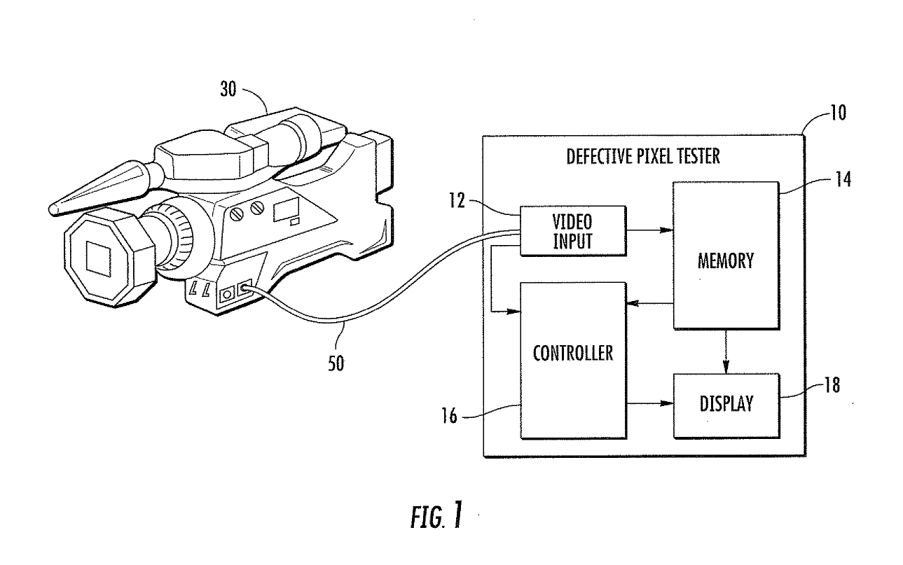

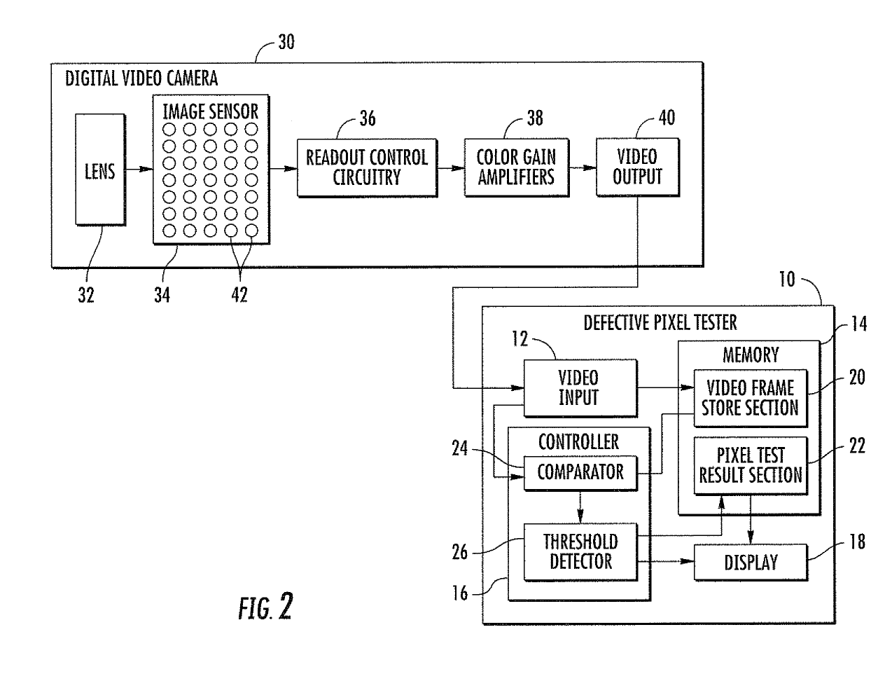

Referring initially to FIGS. 1 and 2, a defective pixel tester 10 is coupled to a digital video camera 30 via an interface cable 50 for determining if there are defective pixels within the camera. The illustrated digital video camera 30 includes a lens 32, an image sensor 34 which may include one or more color filter arrays, readout control circuitry 36, color gain amplifiers 38, and a video output 40.

The lens 32 focuses images onto the image sensor 34, as well as functioning as a protective cover. The image sensor 34 may be a CMOS sensor chip or a CCD sensor chip, for example, and includes a two-dimensional array of pixels 42 arranged in rows and columns. The image sensor 34 provides pixel values corresponding to red, blue and green colors to the readout control circuitry 36. The color gain amplifiers 38 amplify the pixel values before being provided to the video output 40 as video frames, where each video frame is defined by a plurality of pixel values.

The defective pixel tester 10 includes a video input 12 for receiving the video frames from the digital video camera 30. A memory 14 is coupled to the video input 12 for storing captured video frames and pixel test results. A controller 16 is coupled to the video input 12 and to the memory 14 for generating difference values for corresponding pixel values from different video frames, and generates pixel test results based upon a comparison of the difference values to a threshold. The pixel test results are stored in the memory 14 and may be viewed via a display 18.

The memory 14 within the defective pixel tester 10 is illustrated as a single memory device or chip, and includes a video frame store section 20 and a pixel test result section 22. The video frame store section 20 operates as a frame store for storing the received video frames, and the pixel test result section 22 is for storing the test results. Although the memory 14 is illustrated as a single memory device or chip, it may be replaced by two different memory device: one for the video frame store section 20 and one for the pixel test result section 22.

The controller 16 includes a comparator 24 and a threshold detector 26. When the testing is to begin, the controller 16 clears the pixel test results section 22. The pixel test results section 22 may be set to all zeros, for example, indicating that all the pixels 42 in the image sensor 34 are defective. As will be explained in greater detail below, the testing involves repeatedly checking each pixel 42 over a period of time. If a pixel 42 is determined to not be stuck-on or stuck-off during any one of the tests, then a high value is written to the test results section 22 for that pixel and remains during the testing. The pixel test results section 22 is then read after the period of timer which may be after 1 minute, for example. If any of the locations in the pixel test results section 22 are still zero, then the pixels corresponding to those locations are stuck.

During the testing, the video input 12 receives video frames from the digital video camera 30 via the interface cable 50. The video frames provided by the digital video camera 30 may be real time video images corresponding to the general area surrounding the camera. In other words, no special colored black and white backgrounds are used to test for defective pixels within the digital video camera 30. Instead, normal operation of the camera providing different real time images will be acceptable for testing.

For discussion purposes, the received video frames are sequentially received and are numbered as video frames 1, 2, 3, 4 and so on. When video frame 1 is received, it is stored in the video frame store section 20. When video frame 2 is received by the video input 12, it is provided to the controller 16.

Within the controller 16, the comparator 24 receives video frame 1 from the video frame store section 20 and receives video frame 2 from the video input 12. The comparator 24 determines the difference between each pixel value between the video frames 1 and 2. The determined differences for each of the pixels between video frame 1 and video frame 2 are then provided to a threshold detector 26. If a pixel difference is greater than a threshold, then that pixel 42 is considered to be acceptable. In other words, when a pixel difference exceeds the threshold, then that pixel 42 is responding to a difference in light intensities between video frames 1 and 2 and is not stuck.

The threshold may be set at a value of 25, for example, which corresponds to about 10% of the value range of a pixel. A pixel may typically have a possible value between 0 and 255. Similarly, if the pixel difference is less than the threshold, then that pixel 42 is considered to be stuck. The pixel test results between video frames 1 and 2 are then written to the pixel test results section 22.

Since some of the pixel values may experience little or no change between video frames 1 and 2 as a result of the same image being viewed by the digital video camera 30 and not as the result of a defective pixel, the test is repeated for video frames 2 and 3. Video frame 2 is stored in the video frame store section 20. When video frame 3 is received by the video input 12, it is also provided to the controller 16.

Within the controller 16, the comparator 24 receives video frame 2 from the video frame store section 20 and receives video frame 3 from the video input 12. The comparator 24 determines the difference between each pixel value, and the determined differences for each of the pixels between video frames 2 and 3 are provided to the threshold detector 26. If a pixel difference is greater than a threshold, then that pixel 42 is considered to be acceptable and a one is written in the pixel test results section 22.

For the logic ones written in the pixel test results section 22 as a result of the comparison between video frames 1 and 2, they will remain as logic ones regardless of the subsequent test results. However, for the zeros that remain in the pixel test results section 22 as a result of the comparison between video frames 1 and 2, they will change to logic ones and remain as logic ones if any of the subsequent tests generate a difference exceeding the threshold.

The controller 16 thus repeats the generating and storing using one of the video frames previously used to generate the pixel test results last stored in the memory 14. The memory 14 may be an SDRAM or SRAM, for example.

In the video frame store section 20 of the memory 16, two frame store sections may be used. One of the video frame store sections receives a video frame from the video input 12 as the other video frame store section 20 outputs the previously stored video frame to the controller 16. For example, video frame 1 is read by the controller 16 from video frame store section A as video frame 2 is stored in video frame store section B. After the comparator 24 compares video frames 1 and 2, video frame store section B outputs video frame 2 to the controller 16 as video frame store section A stores video frame 3. After the comparator 24 compares video frames 2 and 3, video frame store section A outputs video frame 3 to the controller 16 as video frame store section B stores video frame 4. This ping-ponging continues back and forth between the video frame store sections A and B.

Alternatively, the video frames could be read and written from the same video frame store section 20 at the same time if the bandwidth is high enough. As readily appreciated by those skilled in the art, each consecutive frame does not need to be stored. Instead, every other frame may be stored.

In the above-described embodiment, the pixels 42 in the image sensor 34 mirror the pixel test results in the pixel test results section 22 of the memory 14. Another embodiment for storing the pixel test results in the pixel test results section 22 of the memory 14 is based on a position location of the pixel within the image sensor 34 and whether or not the pixel is failed or functional.

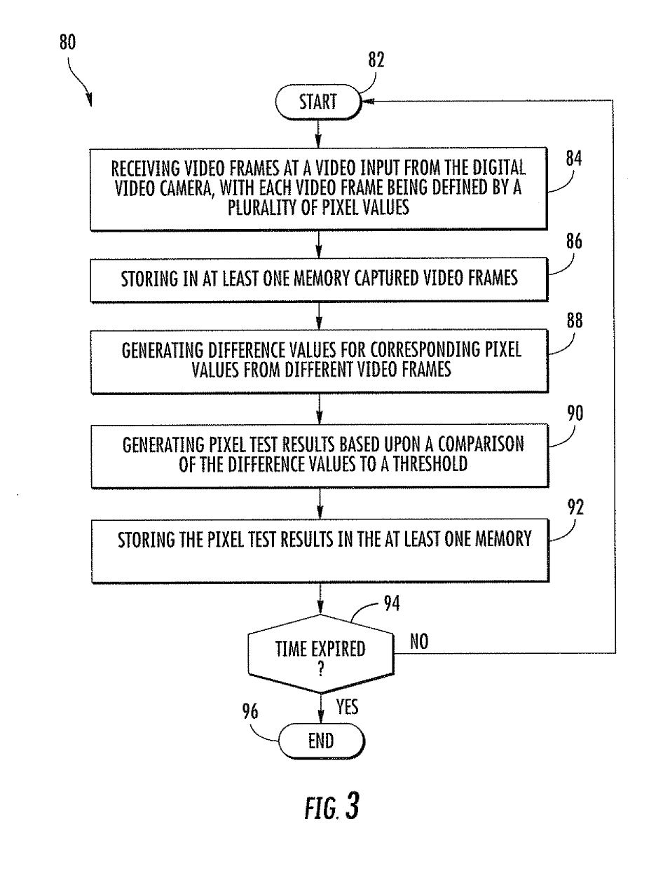

Referring now to FIG. 3, a flow chart 80 illustrating a method for determining defective pixels within the digital video camera 30 will be discussed. From the start (Block 82), the method comprises receiving video frames at the video input from the digital video camera at Block 84, with each video frame being defined by a plurality of pixel values. Captured video frames are stored in the at least one memory 14 at Block 86. The controller 16 may be operated for generating difference values for corresponding pixel values from different video frames at Block 88, generating pixel test results based upon a comparison of the difference values to a threshold at Block 90, and storing pixel test results in the at least one memory 16 at Block 92.

At Block 94, a determination is made as to whether or not time has expired for performing the testing. If the time has not expired, then the method loops back to Block 84 to repeat the storing and generating. If the time has expired, meaning that a number of different video frames have been tested, then the method ends at Block 96.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A defective pixel tester for determining defective pixels within a digital video camera, the tester comprising:
a video input for receiving video frames from the digital video camera, with each video frame being defined by a plurality of pixel values;
at least one memory for storing captured video frames and pixel test results; and
a controller for
generating difference values for corresponding pixel values from different video frames,
generating pixel test results based upon a comparison of the difference values to a threshold, and
storing the pixel test results in said at least one memory.

2. The defective pixel tester according to claim 1 wherein said controller performs the generating and storing on successive video frames.

3. The defective pixel tester according to claim 1 further comprising a display cooperating with said at least one memory for displaying the pixel test results.

4. The defective pixel tester according to claim 1 wherein said video input receives the video frames from the digital video camera in real time.

5. The defective pixel tester according to claim 1 wherein said at least one memory comprises a video frame store section for storing captured video frames, and a pixel test results section for storing pixel test results.

6. The defective pixel tester according to claim 5 wherein said controller resets said pixel test results section prior to determining defective pixels within the digital video camera.

7. The defective pixel tester according to claim 5 wherein said controller receives a current captured video frame from said video frame store section and a new video frame as received by said video input; and wherein said controller performs the generating and storing on these two video frames.

8. The defective pixel tester according to claim 7 wherein the new video frame is also stored in said video frame store section as a new current captured video frame; and wherein said controller receives the new current captured video frame from said video frame store section and a different new video frame as received by said video input; and wherein said controller repeats the generating and storing on these two video frames.

9. The defective pixel tester according to claim 7 wherein said controller repeats the generating and storing using one of the video frames previously used to generate the pixel test results last stored in said at least one memory.

10. The defective pixel tester according to claim 1 wherein said controller comprises:
a comparator for generating the difference values; and
a threshold circuit for comparing the difference values to the threshold.

11. A defective pixel tester comprising:
a video input for receiving video frames from a digital video camera, with each video frame being defined by a plurality of pixel values;
at least one memory comprising a video frame store section for storing captured video frames, and a pixel test results section for storing pixel test results; and
a controller comprising
a comparator cooperating with said video frame store section for generating difference values for corresponding pixel values from different video frames, and
a threshold circuit for generating pixel test results based upon a comparison of the difference values to a threshold, and for storing the pixel test results in said pixel test results section.

12. The defective pixel tester according to claim 11 wherein said comparator and threshold circuit perform the generating and storing on successive video frames.

13. The defective pixel tester according to claim 11 further comprising a display cooperating with said at least one memory for displaying the pixel test results.

14. The defective pixel tester according to claim 11 wherein said video input receives the video frames from the digital video camera in real time.

15. The defective pixel tester according to claim 11 wherein said controller receives a current captured video frame from said video frame store section and a new video frame as received by said video input; and wherein said controller performs the generating and storing on these two video frames.

16. The defective pixel tester according to claim 15 wherein the new video frame is also stored in said video frame store section as a new current captured video frame; and wherein said controller receives the new current captured video frame from said video frame store section and a different new video frame as received by said video input; and wherein said controller repeats the generating and storing on these two video frames.

17. A method for determining defective pixels within a digital video camera using a defective pixel tester comprising a video input, at least one memory and a controller, the method comprising:
receiving video frames at the video input from the digital video camera, with each video frame being defined by a plurality of pixel values;
storing in the at least one memory captured video frames; and
operating the controller for
generating difference values for corresponding pixel values from different video frames,
generating pixel test results based upon a comparison of the difference values to a threshold, and
storing pixel test results in the at least one memory.

18. The method according to claim 17 wherein the controller performs the generating and storing on successive video frames.

19. The method according to claim 17 wherein the defective pixel tester further comprises a display cooperating with the at least one memory for displaying the pixel test results.

20. The method according to claim 17 wherein the video input receives the video frames from the digital video camera in real time.

21. The method according to claim 17 wherein the at least one memory comprises a video frame store section for storing captured video frames, and a pixel test results section for storing pixel test results.
